(19) United States
(12) Patent Application Publication
(10) Pub. No.: US 2025/0128864 A1
(43) Pub. Date: Apr. 24, 2025

(54) CAN ENDS, METAL CANS AND APPARATUS FOR DISPENSING THEREFROM

(71) Applicant: Crown Packaging Technology, Inc., Tinley Park, IL (US)

(72) Inventors: Matthew Twiss, Wantage, Oxfordshire (GB); Luke Moreland, Wantage, Oxfordshire (GB)

(73) Assignee: Crown Packaging Technology, Inc., Tinley Park, IL (US)

(21) Appl. No.: 18/730,682

(22) PCT Filed: Jan. 6, 2023
(86) PCT No.: PCT/GB2023/050021

§ 371 Date: Jul. 19, 2024

(30) Foreign Application Priority Data
Jan. 27, 2022 (GB) 2201054.0

(51) Int. Cl. B65D 51/22; B05B 11/10

(52) U.S. Cl. CPC B65D 51/222; B05B 11/1043; B65D 2543/00277; B65D 2543/00425; B65D 2543/00953

(57) ABSTRACT

A tab-less metal can end for seaming onto a metal can body. The can end comprises a substantially circular and planar panel, a chuck wall extending around the periphery of the panel and defining a curl, and a discontinuous score formed in said panel and following a circular path substantially concentric with said chuck wall, the score defining a hinge between first and second ends of the score.

### TECHNICAL FIELD

The present invention relates can ends, metal cans and apparatus for dispensing therefrom. More particularly, the invention relates to tab-less can ends with scored features that can be opened by means of a dispenser.

### BACKGROUND

Currently, many products including household products such as detergents and personal care products are supplied in disposable plastic containers. It is widely recognised that such use of plastic containers is undesirable not least because of the environmental damage that arises from the disposal of such containers. Metal containers can provide a more environmentally friendly alternative and of course many products are already supplied in metal containers including foodstuffs, aerosols, mousses and the like. Such metal containers are often made using a relatively thick steel or aluminium which, whilst allowing for recycling, can be wasteful in terms of the materials used. They are also relatively expensive to manufacture and have higher manufacturing and transportation costs and therefore larger carbon “footprints”, discouraging their use as a replacement for plastic containers.

WO2021/138708 describes a product dispensing system that makes use of what are substantially aluminium beverage cans. The can ends are either openable with tabs, e.g. in the form of a substantially fully open ends, or are provided with circular apertures closed with foil panels. The cans are filled with product and, for use, are loaded into a plastic two-part container comprising a main, generally cylindrical body and an end dispenser. In the case of an end with a tab, the end is opened by pulling the tab, and the can loaded into the body with the end dispenser being screwed over the can and onto the main body. The end dispenser is of a pump type and comprises a tube which is inserted through the opening in the can end. Once the end dispenser is secured to the main body, product can be dispensed. In the case where the can end has a foil panel, securing the end dispenser to the main body may cause the tube to break through the foil panel and pass into the can body.

Conventional beverage can production is highly optimised in terms of material use and manufacturing speed and cost. The use of a tab in the concept described in WO2021/138708 is undesirable as it will increase metal usage, complexity and therefore cost. Whilst the use of a foil panel instead of a tab may address this problem, it will in turn introduce potential problems due to the departure from conventional end manufacturing processes. Furthermore, this approach will likely require the use of an adhesive, e.g. on the underside of the can end, potentially causing product contamination and/or product deterioration, as well as providing a weak point in the can end, e.g. the foil panel may be susceptible to breaking during transport as well as due to internal and external pressures.

WO2012/136677 discloses a self-dispensing container for carbonated product and comprising a hollow body having a filling aperture, a carbonated product inserted into the hollow body via the filling aperture leaving a headspace, and an end adapted to seal the filling aperture after insertion of the carbonated product. After sealing, the headspace fills with CO2 from the carbonated product to equalise the pressure within the container.

WO2016/170883 discloses a can having a tab-less end. A score extends around a region of the end such that a user can press down on the region within the score, fracturing the score and creating an opening in the end.

### SUMMARY

According to the first aspect of the invention there is provided a tab-less metal can end for seaming onto a metal can body. The can end comprises a substantially circular and planar panel, a chuck wall extending around the periphery of the panel and defining a curl, and a discontinuous score formed in said panel and following a circular path substantially concentric with said chuck wall, the score defining a hinge between first and second ends of the score. Preferably, the score is of a depth which cannot be fractured with the pressing of a thumb or finger and requires some device which gives mechanical advantage to open it.

The planar panel of the can end may define an outer surface and an inner surface when the end is seamed to a can body, and the panel having a thickness in the range 0.193-0.224 mm, said discontinuous score being formed in the outer surface of the panel and resulting in a score residual of 0.07 mm+0.03 mm. The can end may have an outermost (seamed) diameter of substantially 52 mm. The circular path of the can end may have a diameter of approximately 19 mm. The hinge of the can end may have a linear extent of between 1 and 4 mm, preferably between 2 and 4 mm, and more preferably 3 mm.

The panel of the can end may be formed so as to provide one or more concentric steps to define terraces in the panel including, for example, a terrace radially inside of the score and/or a terrace radially outside of said score. The can end may further comprise a first concentric step having a radius substantially 3.5 mm greater than the radius of said circular path and a second concentric step having a radius substantially 3.2 mm less than the radius of said circular path.

The can end may be made of steel, aluminium, or an aluminium alloy.

According to a second aspect of the invention there is provided a can body and a can end of the first aspect of the invention, the can end being seamed onto the can body to close an opening in the can body. The can body may be closed at an end opposed to said opening.

The interior of the can may be pressurised at 68.9 kPa or more.

The can body may be made of steel, aluminium, or an aluminium alloy.

According to a third aspect of the invention there is provided a dispenser for use with the can of the second aspect of the invention. The dispenser comprises a main body for receiving the can, and a lid. The main body and the lid have cooperating features for removably securing the lid to the main body, and the lid comprises a piercing member configured to fracture the score provided in the can end and create an opening therethrough and thereby bring the interior of the can into communication with an interior space of the lid.

The cooperating features of the lid and the main body may comprise cooperating screw threads.

The piercing member may be provided by a hollow cylindrical member which defines said interior space, the cylindrical member having a variable axial length such that it provides a tip for fracturing said score. The dispenser may further comprise a resilient sealing member extending around said cylindrical member to form a seal around or adjacent to the opening formed in the can end by the fracturing of the score. The dispenser may further comprise a dispensing cap removably secured to said lid and defining a channel through which a product can flow from an interior space of the can to an exterior of the dispenser. The dispensing cap may further comprise a tube for insertion through the opening in the can end, said tube defining said channel. The dispensing cap may further comprise a resilient sealing member configured to form a seal between the dispensing cap and the lid.

According to a fourth aspect of the invention there is provided a system for dispensing a product and comprising the dispenser of the third aspect of the invention and the can of the second aspect of the invention.

According to a fifth aspect of the invention there is provided system for dispensing a product and comprising a can having a can body containing said product and a can end seamed onto the can body, and a dispenser, wherein the can end comprises a substantially circular and planar panel, a chuck wall extending around the periphery of the panel and defining a curl, and a discontinuous score formed in said panel, the score defining a hinge between first and second ends of the score. The dispenser comprises a lid having features for removably securing the lid with respect to the can, and the lid comprising a piercing member configured to fracture the score provided in the can end and create an opening therethrough and thereby bring the interior of the can into communication with an interior space of the lid.

As will be appreciated from the embodiments described herein, the lid of the dispenser may be fixed directly to the can or may be fixed to a container body, in the form of a cup or the like, configured to hold the can.

### BRIEF DESCRIPTION OF THE DRAWINGS

FIG. 1A shows a plan view of a can end with a score;

FIG. 1B shows a top perspective view of the can end of FIG. 1A;

FIG. 1C shows a bottom perspective view of the can end of FIG. 1A;

FIG. 2 shows a cross sectional view of the can end of FIG. 1A taken along the line A-A, with enlarged call out;

FIG. 3A shows a top perspective view of a can comprising the can end of FIG. 1A seamed to a can body;

FIG. 3B shows a top perspective view of an upper region of the can of FIG. 3A;

FIG. 4 shows an exploded view of a dispenser holding the can of FIG. 3;

FIG. 5 shows the dispenser and can of FIG. 4 in cross section;

FIGS. 6A, 6B, 7A and 7B illustrate steps involved in closing the dispenser about the can;

FIG. 8A shows an enlarged cross sectional view of the can end and a piercing member of the dispenser lid before the dispensing cap has been secured to the lid;

FIG. 8B shows the enlarged cross sectional view of FIG. 8A after the dispensing cap has been secured to the lid;

FIGS. 9A and 9B illustrate alternative means for providing a seal between the lid and the can end;

FIG. 10 shows an alternative dispenser in which the can of FIG. 3 is attached to a lid, and the seal is formed between the lid and the rim of the can end;

FIGS. 11 to 13 illustrate alternative dispensing caps for the dispenser of FIG. 4;

FIGS. 14A and 14B illustrate an alternative dispensing cap for a can; and

FIG. 15 illustrates a still further alternative dispensing cap for the dispenser of FIG. 4.

### DETAILED DESCRIPTION

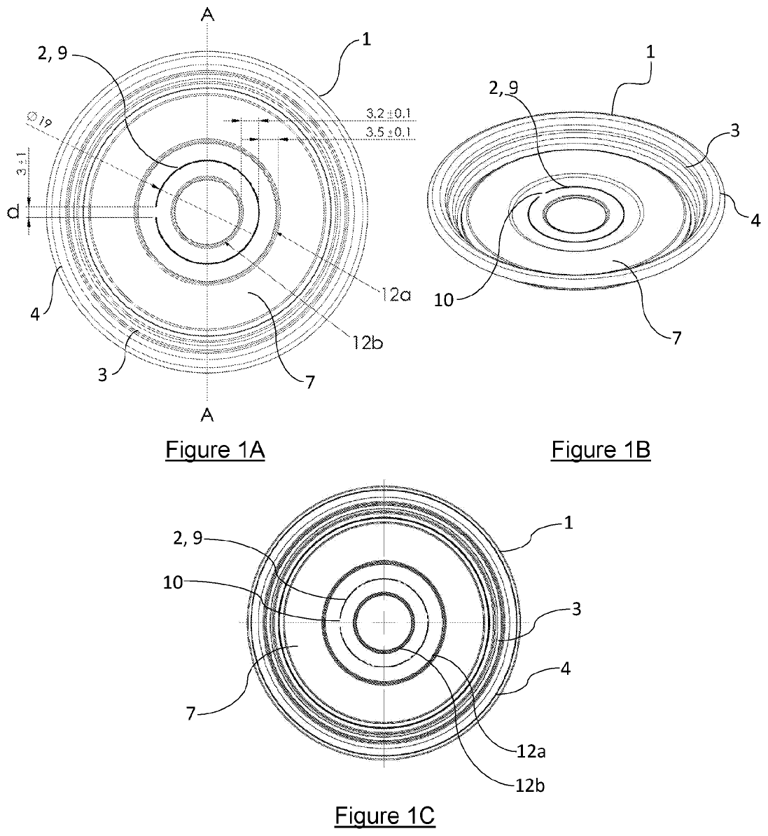

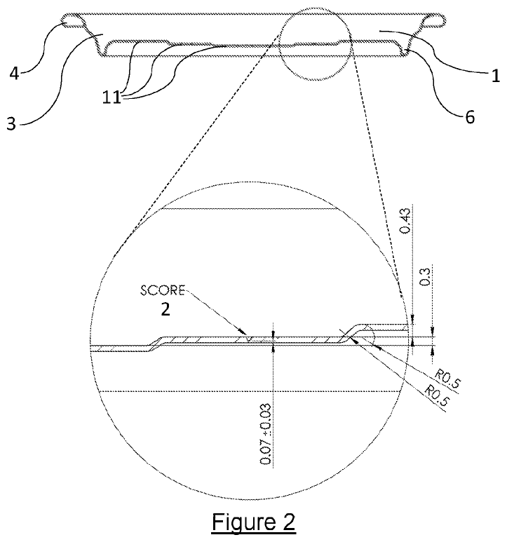

A tab-less can end 1 will now be described with reference to FIGS. 1A to 1C and 2. The can end is similar to standard beverage can ends, and the manufacturing process is also similar. For the purpose of the following discussion, the end 1 is assumed to be a “202” end having a seamed diameter of approximately 52 mm. Of course other end sizes are possible (e.g. “200”, “113”, “206”) and the skilled person will take account of this when determining dimensions of other end features.

The key differences between the end 1 described here and standard ends are the absence of a tab and its associated score, and the provision of a discontinuous score 2. The end 1 is referred to here as a “tab-less end” due to the absence of the tab which is otherwise commonly used in the opening of a can end by pulling or pressing against its associated score, and is created by cutting out circular disks from metal sheet having a thickness in the range of 0.193-0.224 mm. The disks are then formed to provide a chuck wall 3 with a curl 4 at the top to allow seaming of the end 1 onto a can body 5. The chuck wall 3 and curl 4 extend around the entire circumference of the end 1, defining a generally U-shaped channel 6 between the chuck wall 3 and a central panel 7. The score 2 is formed on an upper surface of the panel 7 (i.e. on a surface that is exterior to the can 8 after seaming of the end 1 to a can body 5), and follows a circular path 9 that is substantially concentric with the chuck wall 3. The diameter of the score 2 is approximately 19 mm, and has a depth of between 0.083 and 0.097 mm, preferably approximately 0.09 mm. For the metal thickness considered here, this results in a score “residual” of 0.07 mm±0.03 mm.

As the score 2 is discontinuous, a portion of the circular path 9 is unscored. The unscored portion of the circular path 9 acts as a hinge 10 when the can end 1 is opened as discussed further below. The linear extent, indicated in FIG. 1A by distance d, of the hinge 10 is preferably between 1 and 4 mm, more preferably between 2 and 3 mm, and more preferably substantially 3 mm. The score depth (and therefore score residual) may be adjusted to optimise end performance. In particular, the score depth is deep enough that it can be opened with the aid of some device which gives mechanical advantage, but not so deep that it can be opened with a thumb or a finger pressing directly against it.

As best illustrated in FIG. 2, the panel 7 of the can end 1 is formed to provide three terraces 11 formed by two circular and concentric steps 12a, 12b. A first step 12a has a radius that is substantially 3.5 mm greater than the radius of the score 2, whilst the second step 12b has a radius that is substantially 3.2 mm less than the radius of the score 2. The terraces 11 therefore descend in height towards the centre of the end 1, with the first step 12a having a step height of 0.43 mm and the second step 12b having a step height of 0.3 mm. As is known in the art, the use of such terraces can “absorb” metal displaced during forming operations and can improve end performance by adding strength to the can end 1, minimising “doming” when the can end 1 is seamed onto a can body 5 and pressurised.

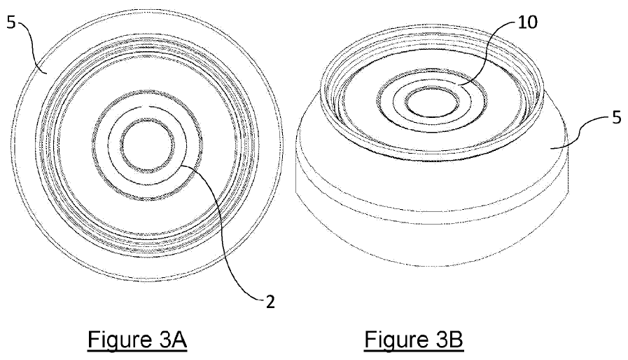

When the can end 1 is seamed onto the can body 5 as shown in FIG. 3 (using a conventional beverage can seaming process), the can end 1 closes an upper opening in the can body 5 (seaming of the end occurs after filling of the can body with a product). For the purpose of this discussion it is assumed that the can 8 is a two-piece can in which a bottom of the can body 5 is formed integrally with the can sidewalls (of course, use of a two-part can body is possible). The contents of the can 8 may be a beverage, a foodstuff, a household cleaning product, or a condiment; however this list is not exhaustive and other products, such as creams, ointments, healthcare and personal care products, and medical products, may be stored in the can 8. Additionally, dry granular products may also be stored in the can 8. Preferably, the can end 1 and the can body 5 are formed of steel, aluminium, or an aluminium alloy, and the filled can is pressurised to at least 10 psi (68.9 kPa). Pressurising the can 8 is helpful in maintaining structural integrity for thin walled cans.

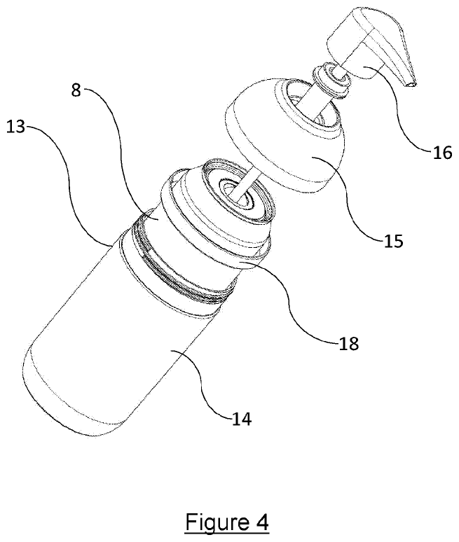

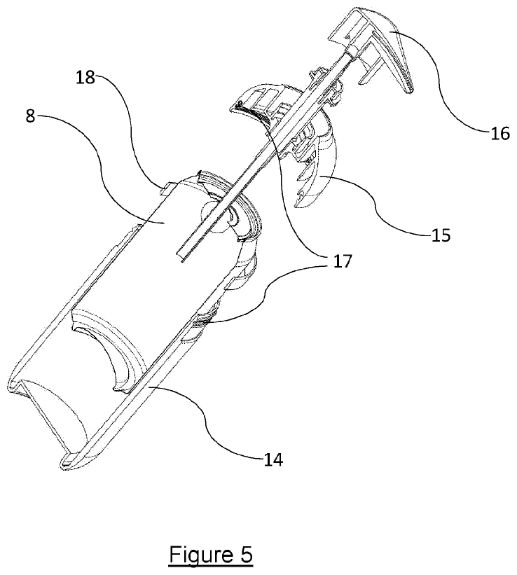

A dispenser 13 for use with the can 8 of FIG. 3 will now be discussed with reference to FIGS. 4 to 6. FIG. 4 shows an exploded view of the dispenser 13 in which the can 8 of FIG. 3 is loaded into a main body or “cup” 14, with a lid 15 and a dispensing cap 16 positioned for attachment to the cup 14, whilst FIG. 5 shows a cross-sectional view of the exploded view of FIG. 4. Both the lid 15 and the cup 14 have cooperating features that allow the lid 15 to be removably secured to the cup 14. In this particular embodiment, the cooperating features are threads 17 that allow the lid 15 and the cup 14 to be screwed together to completely enclose the can 8. Optionally, a circular band 18 of an elastomeric plastic or other suitable material is located around the outside of the cup 14 such that it is “sandwiched” between the lid 15 and the cup 14 following closure, for example, to provide for a leak proof closure whilst preventing or limiting over-tightening. Alternatively, a corresponding circumferential region of the cup may be enlarged to provide a flush outer surface when the lid is attached. The threads 17 are formed on regions of the lid 15 and the cup 14 having reduced thicknesses such that the closed dispenser 13 has a substantially flush outer surface. It will be appreciated that the inner diameter of the cup 14 (and lid 15) are such as to allow the can to be easily inserted and removed. This may require a small space to be present between the outer surface of the can and the cup 14, e.g. on the order of 1 mm. When the can 8 of FIG. 3 is loaded into the dispenser 13, the cup 14 provides additional support to the can 8 once it has been opened and potentially depressurised. The cup 14 and lid 15 may be made of metal, plastic or any other suitable material, as may other components of the dispenser.

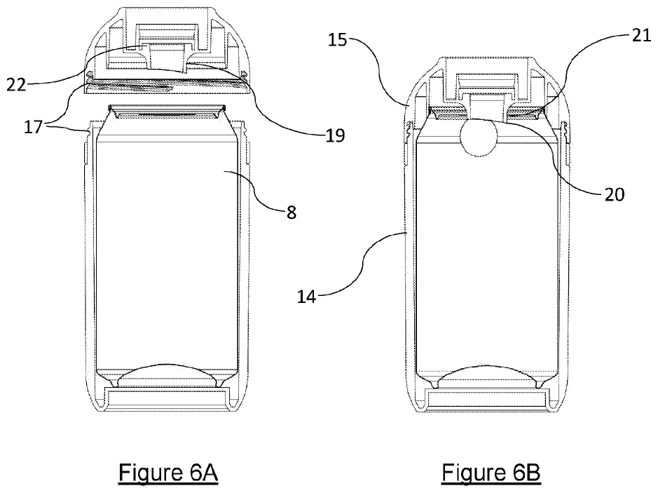

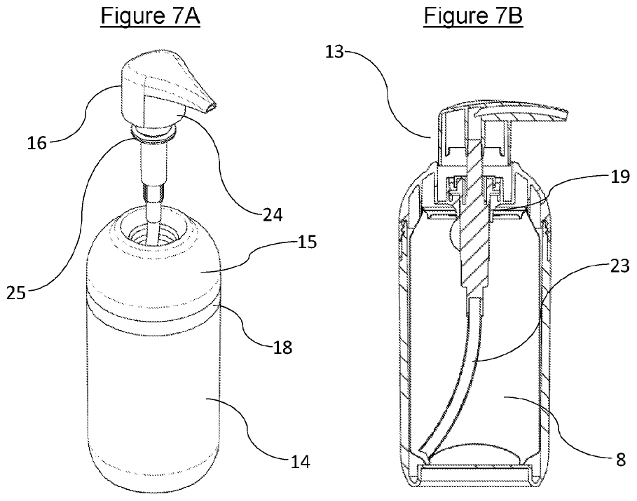

As is perhaps best illustrated in the cross-sectional views of FIGS. 6A (at initiation of closure of the lid 15) and 6B (during closure of the lid 15), the lid 15 has a piercing member 19 that is configured to fracture the score 2 of the can end 1 upon closure, and thereby create an opening which brings the interior of the can 8 into communication with an interior space of the lid 15. The piercing member 19 acts as a device which gives mechanical advantage during closure, enabling the score 2 to be fractured during closure. The piercing member 19 has the form of a hollow cylindrical member that is concentric with the outer surface of the lid 15. The piercing member 19 has an axial length that varies around its circumference providing a tip 20. To allow effective fracturing of the score 2 upon closure, the outer diameter of the hollow cylindrical member 19 is very slightly less than the inner diameter of the score 2. As will be discussed further below, the lid 15 comprises a resilient sealing member 21 in the form of an O-ring or the like, and which is located around the outer circumference of the piercing member 19, supported beneath a collar 22 extending circumferentially around the outer surface of the piercing member 19.

FIGS. 7A and 7B show a pump-style dispensing cap 16 comprising a tube 23, a pump head 24, and a pumping mechanism (not shown but including, for example, a spring), located with respect to the cup 14 and loaded can 8. The dispensing cap 16 can be removably secured to the lid 15 (cf. FIGS. 7A and 7B). When the dispensing cap 16 is secured to the lid 15, e.g. via a snap-fit arrangement, a channel is defined through which a product can flow from the interior space of the can 8 to an exterior of the dispenser 13. The dispensing cap 16 also comprises a resilient sealing member 25 that forms a seal between the dispensing cap 16 and the lid 15 (see below). The resilient sealing member 25 may be in the form of a flattened elastomeric ring, an O-ring, or other suitable resilient member. The dispensing cap 16 does not of course need to be a pump-type dispenser and may be some other type of dispenser or valve as discussed below.

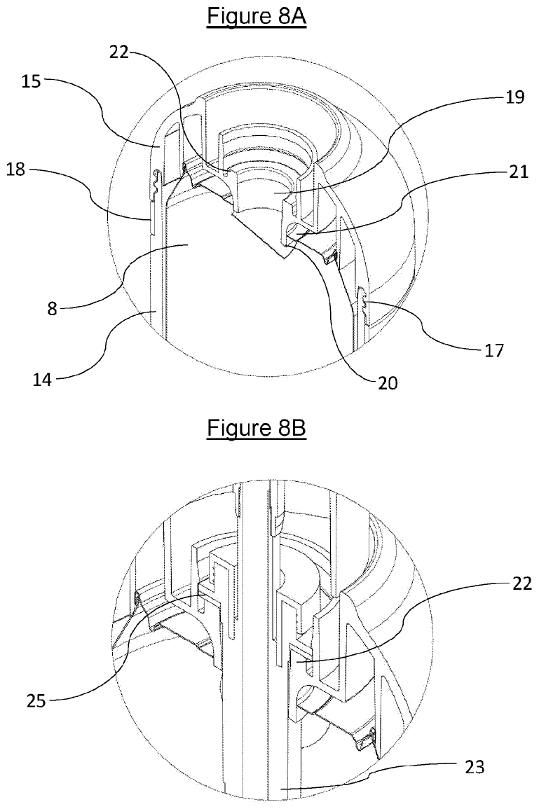

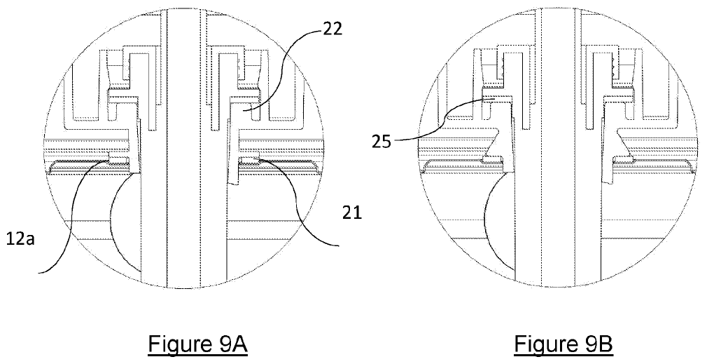

The operation of assembling the dispenser 13 around a can 8 will now be described. Reference to the cross-sectional detail of FIG. 8A will be helpful in this regard.

A user loads a can (filled with product) into the dispenser cup 14. The lid 15 is located on the open end of the cup 14, above the tab-less can end. The user then presses the lid 15 onto the cup 14, with the threads 17 aligned, and rotates the lid 15 relative to the cup 14 to screw the lid 15 down onto the cup 14. This action provides the mechanical advantage that causes the tip 20 of the piercing member (the hollow cylinder) 19 to exert a force on a point just inside the score 2, causing the score to fracture at this point. As the user continues to screw the lid 15 down, the fracture will propagate around the score 2, whilst pushing the panel region within the score 2 into the can body 5. The fracture stops at the hinge 10 of course. The hinge 10 prevents the portion of the can end 1 that is outlined by the score 2 from fully separating from the can end 1. Upon completion of this operation, the resilient sealing member 21 surrounding the piercing member 19 is pressed into the opening, or around the panel region surrounding the formed opening, thereby establishing a seal between the interior of the can 8 and an interior space of the lid 15.

It will be appreciated that this construction and method of operation allows the end 1 to be opened without the use of a tab. The can end 1 can be manufactured with fewer steps and with reduced metal. Furthermore, because the underside of the can end 1 does not use or expose an adhesive, undesirable material interactions and product contamination are avoided. A still further advantage is that the cans 8 may be more effectively child-proofed, given that the cans 8 can only be opened with a suitable dispenser 13 which provides the needed mechanical advantage (or lid in the case where a container body is not required). Of course, the absence of a tab or ring pull means that the can 8 is not similar in appearance to a standard beverage can, and so is less likely to be mistaken for a can containing a typical single serve consumable product or indeed non-consumable product.

After the lid 15 has been secured to the cup 14 as described, the dispensing cap 16 is secured to the lid 15 by inserting the tube 23 through the interior space of the lid 15 until the resilient sealing member 25 is engaged beneath a circular shoulder extending around an upstanding cylindrical collar 22 of the lid 15. This is best illustrated by the detail of FIG. 8B. The formed seal prevents the contents of the can 8 from leaking into the lid 15. The seal is also required of course to allow the dispensing cap 16 to pressurise the interior of the can 8 during operation of the pump, thereby causing the product to be forced up into the tube 23 and out through an exit port of the dispensing cap.

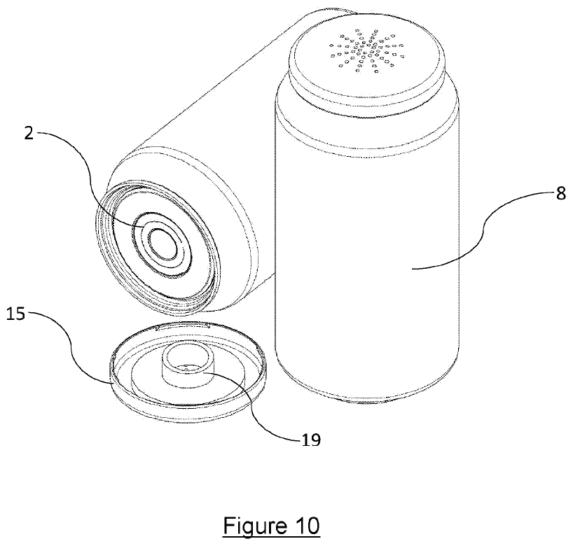

FIGS. 9A and 9B show details of the various embodiments with different seal arrangements. In the embodiments of FIG. 9A, the resilient sealing member 21 of the lid 15 provides a seal around or adjacent to the opening formed in the can end 1 by the fracturing of the score 2. In the embodiment of FIG. 9A, the resilient sealing member 21 of the lid 15 presses against the portion of the can end 1 surrounding the score 2 to form the seal. The outer diameter of the sealing member 21 is marginally less than the diameter of the outer step 12a such that on closure the resilient sealing member 21 presses not only downwards onto the panel 7 but also radially against the step.

The embodiment of FIG. 9B is similar to that of FIG. 9A, except that in the former the wall of the piercing member above the shoulder supporting the resilient sealing member is circularly cylindrical whilst in the latter that wall has a tapering thickness, increasing as it approaches the shoulder. The embodiment of FIG. 9B may demonstrate increased strength and rigidity, especially during closure of the lid 15 onto the cup 14.

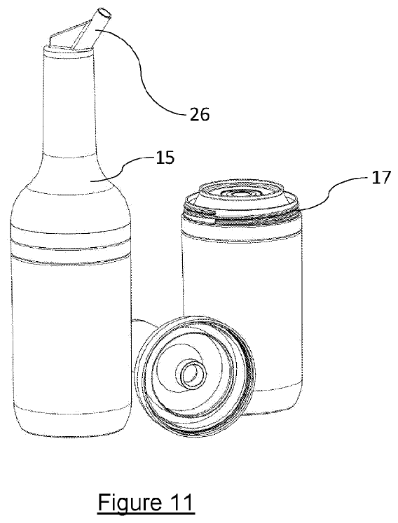

It will be appreciated that by configuring the lid 15 to form a suitable seal around the top of the can 8 it is possible to do away with the need for the dispenser 13 to have a cup 14 to support the can 8. Such an arrangement is shown in FIG. 10 and comprises a lid 15 secured directly to the can 8. In order to provide the force necessary for the piercing member 19 to fracture the score 2 and open the can end 1, a snap-fit mechanism may be provided, whereby the user locates the lid 15 around the upper surface of the can 8, and presses down onto the lid 15 to cause features of the lid 15 to snap over and beneath the rim extending around the can end 1. This action also forces the piercing member 19 downwards, fracturing the score 2.

Reference is made to FIGS. 11 to 14 which illustrate further configurations and uses of the dispenser 13:

FIG. 11: The pump-type dispenser cap 16 described above is replaced by a pouring spout 26 which may be formed integrally with the lid 15. This is suitable, for example, for dispensing alcoholic beverages such as spirits, non-alcoholic cordial concentrates, or syrups or sauces. The cup 14 of the dispenser 13 may be of a transparent plastic material allowing branding printed on the can body 5 to be visible through the cup 14.

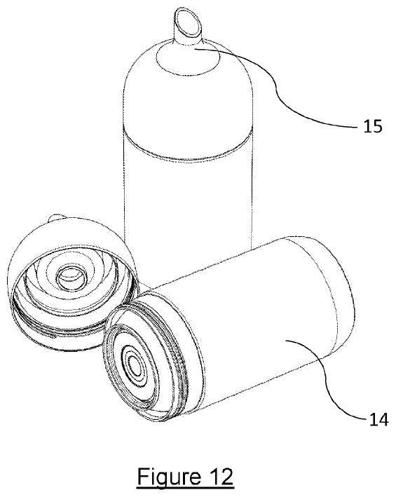

FIG. 12: This arrangement is similar to that of FIG. 11 and is suitable for pouring liquids such as oil, as well as dry products such as sugar and coffee beans. An attractive design is created by manufacturing the dispenser 13 using a metal such as steel or aluminium, or with a chrome coated plastics.

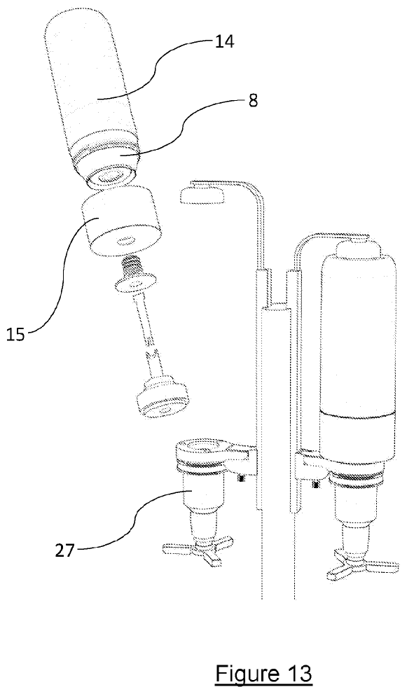

FIG. 13: The pump-type dispenser 13 is replaced with an “optics” connector 27 suitable for dispensing, for example, a spirit, non-alcoholic cordial concentrates, or syrups or sauces. Again, by forming the dispenser cup 14 from a transparent plastic material, branding printed on the can body 5 is visible in use.

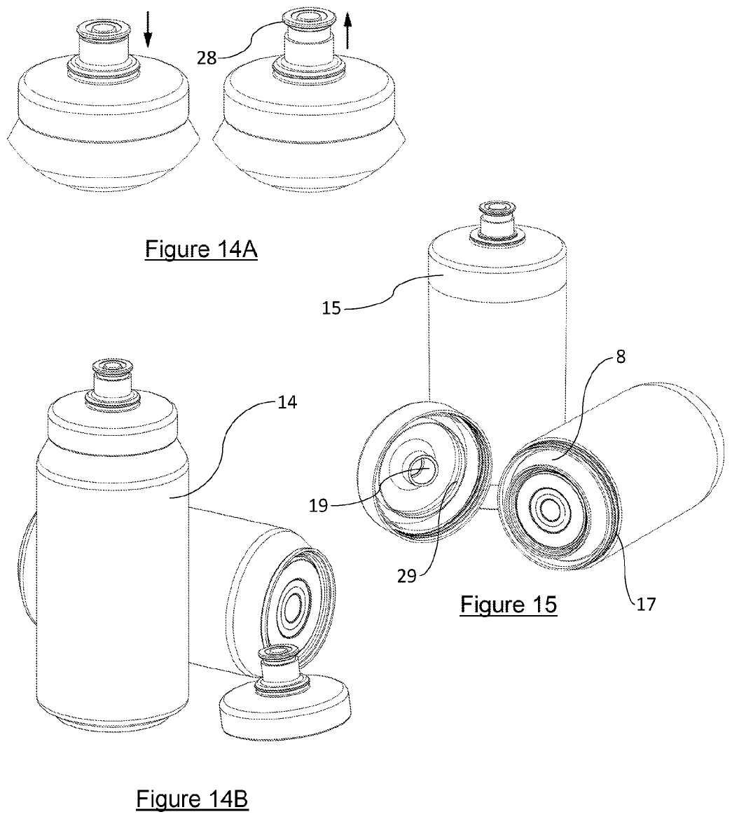

FIGS. 14A and 14B: The pump-type dispenser cap 16 described above is replaced by a push pull cap 28 which may be formed integrally with the lid 15. Such a cap 28 is suitable, for example, for direct consumption of the contents of the can 8, such as water or another beverage. Alternatively, the contents of the can 8 may still be poured from the push pull cap 28 when it is in an open position. The lid 15 may have an internal cylindrical collar 29 with an O-ring around the inner circumference such that when the lid 15 is pressed in place over a can end, a seal is formed between the collar and the curl 4 of the can end 1. The seal keeps the contents of the can 8 within the cylindrical volume created between the collar 29 and the curl of the can end 1.

FIG. 15 illustrates a further embodiment with a similar lid to that of the embodiment of FIGS. 14A and 14B. However, the lid is configured to be attached to a dispenser cup 14 of the type previously described, e.g. by means of cooperating screw threads.

It will be appreciated by the person of skill in the art that various modifications may be made to the above described embodiments without departing from the scope of the present invention. For example, the size of the can 8 may be different from that of a standard (330 ml) beverage can to allow storage of different amounts of product. For a larger can size, the can body may be “necked” to allow for use with a standard sized can end 1. A larger can 8 is advantageous over standard large storage containers such as glass bottles because the weight of the large can 8 will be less than the corresponding glass bottle. While terracing has been used in the present description to increase the strength of the can end 1, beading could also be used to increase the strength of the can end 1. For example, radial beads could be used either in addition to the terracing, or instead of the terracing, on the can end 1. Using radial beading in addition to terracing could allow for larger can ends 1 to be manufactured that are still strong enough to withstand internal and external pressure.

In understanding the above embodiments, reference should be made to the following table which identifies reference numerals and features of the drawings.

| Reference | |
|---|---|
| numeral | Feature |
| 1. | Can end |
| 2. | Score |
| 3. | Chuck wall |
| 4. | Curl |
| 5. | Can body |
| 6. | U-shaped channel |
| 7. | Central panel |
| 8. | Can |
| 9. | Circular path |
| 10. | Hinge |
| 11. | Terraces |
| 12. a & b | Steps |
| 13. | Dispenser |
| 14. | Main body/cup |
| 15. | Lid |
| 16. | Dispensing cap |
| 17. | Threads |
| 18. | Band |
| 19. | Piercing member |
| 20. | tip |
| 21. | Resilient sealing member (piercing member) |
| 22. | Collar |
| 23. | Tube |
| 24. | Pump head |
| 25. | Resilient sealing member (dispensing cap) |
| 26. | Pouring spout |
| 27. | Drinks optics |
| 28. | Push pull cap |
| 29. | Internal cylindrical collar |

1. A tab-less metal can end for seaming onto a metal can body and comprising:
a substantially circular and planar panel;
a chuck wall extending around the periphery of the panel and defining a curl; and
a discontinuous score formed in said panel and following a circular path substantially concentric with said chuck wall, the score defining a hinge between first and second ends of the score.

2. A can end according to claim 1, the discontinuous score being such that it can be fractured by a user only by an average adult user when the user makes use of a mechanical advantage.

3. A can end according to claim 1, the planar panel defining an outer surface and an inner surface when the end is seamed to a can body, and the panel having a thickness in the range 0.193-0.224 mm, said discontinuous score being formed in the outer surface of the panel and resulting in a score residual of 0.07 mm±0.03 mm.

4. A can end according to claim 1 and having an outermost seamed diameter of substantially 52 mm.

5. A can end according to claim 1, said circular path having a diameter of approximately 19 mm.

6. A can end according to claim 1, said hinge having a linear extent of between 1 and 4 mm, preferably between 2 and 4 mm, and more preferably 3 mm.

7. A can end according to claim 1, said panel being formed so as to provide one or more concentric steps to define terraces in the panel including, for example, a terrace radially inside of the score and/or a terrace radially outside of said score.

8. A can end according to claim 7 and comprising a first concentric step having a radius substantially 3.5 mm greater than the radius of said circular path and a second concentric step having a radius substantially 3.2 mm less than the radius of said circular path.

9. A can end according to claim 1, the can end being of steel, aluminium, or an aluminium alloy.

10. A can comprising a can body and a can end according to claim 1, the can end being seamed onto the can body to close an opening in the can body.

11. A can according to claim 10, said can body being closed at an end opposed to said opening.

12. A can according to claim 11, an interior of the can being pressurised at 68.9 kPa or more.

13. A can according to claim 10, said can body being of steel, aluminium, or an aluminium alloy.

14. A dispenser adapted for use with the can of claim 10, the dispenser comprising:
a lid having features for removably securing the lid with respect to the can, and the lid comprising a piercing member configured to fracture the score provided in the can end and create an opening therethrough and thereby bring an interior of the can into communication with an interior space of the lid.

15. A dispenser according to claim 14, said features comprising sealing features for removably securing the lid directly to the can.

16. A dispenser according to claim 15, said sealing features providing a substantially fluid tight seal between the lid and an outer surface or surfaces of the can.

17. A dispenser according to claim 14 and comprising a main body for receiving the can, the main body comprising features for cooperating with said features of the lid to fix the lid to the main body, about a can.

18. A dispenser according to claim 17, said cooperating features of the lid and the main body comprising cooperating screw threads.

19. A dispenser according to claim 14, said piercing member being provided by a hollow cylindrical member which defines said interior space, the cylindrical member having a variable axial length such that it provides a tip for fracturing said score.

20. A dispenser according to claim 19 and comprising a resilient sealing member extending around said cylindrical member to form a seal around or adjacent to the opening formed in the can end by the fracturing of the score.

21. A dispenser according to claim 19, and comprising a dispensing cap removably secured to said lid and defining a channel through which a product can flow from an interior space of the can to an exterior of the dispenser.

22. A dispenser according to claim 21, said dispensing cap comprising a tube for insertion through the opening in the can end, said tube defining said channel.

23. A dispenser according to claim 21, said dispensing cap comprising a resilient sealing member configured to form a seal between the dispensing cap and the lid.

24. A system for dispensing a product and comprising a dispenser according to claim 14, and a can according to claim 10.

25. A system for dispensing a product and comprising a can having a can body containing said product and a can end seamed onto the can body, and a dispenser, wherein the can end comprises:
a substantially circular and planar panel;
a chuck wall extending around the periphery of the panel and defining a curl; and
a discontinuous score formed in said panel, the score defining a hinge between first and second ends of the score, and
wherein the dispenser comprises:
a lid having features for removably securing the lid with respect to the can, and the lid comprising a piercing member configured to fracture the score provided in the can end and create an opening therethrough and thereby bring an interior of the can into communication with an interior space of the lid.
